(19) United States
(12) Patent Application Publication
(10) Pub. No.: US 2009/0162610 A1
(43) Pub. Date: Jun. 25, 2009

(54) Synthetic Leather and a Manufacturing Process thereof

(76) Inventor: Jui-Hung Hwang, Taipei (TW)

Correspondence Address: HDLS Patent & Trademark Services, P.O. BOX 220746, CHANTILLY, VA, 20153-0746, US

(21) Appl. No.: 11/960,700

(22) Filed: Dec. 20, 2007

(51) Int. Cl. D06N 3/00; B32B 38/00

(52) U.S. Cl. 428/151; 156/148

(57) ABSTRACT

A synthetic leather and a manufacturing process thereof involves having a substrate to be combined with a thermoplastic basic material (TPU MB) in one-time or multiple times of compound procedure for both to become an integrated party of the synthetic leather that prevents easy stripping off, excellent compound results, and excellent air permeability, particularly ideal in lateral and longitudinal ductility and malleability. Furthermore, the synthetic leather of the present invention gives advantages of having smooth surface, free of pilling, multiple choices for the applicable substrate, and perfect for massive production by batch.

### BACKGROUND OF THE INVENTION

(a) Field of the Invention

The present invention is related to a compound process and finished product of a synthetic leather, and more particularly, to an innovative art of putting a substrate and thermoplastic basic material (TPU MB thermoplastic-polyurethane melt-blown non-woven) under multiple rounds of compound process to produce a synthetic leather that imitates genuine leather.

(b) Description of the Prior Art

Conventional synthetic leather has staple fiber as the substrate, surface of the substrate is then PU film lamination processed before the final process of embossed pattern press to come up with the finished product of synthetic leather. However, both of the substrate and the PU film could be easily stripped off since they are only laminated to each other; as a result, the major defect found with the conventional process is that the synthetic leather is vulnerable to be damaged. Furthermore, the PU film in the conventional synthetic leather has a poor air permeability to cause the scope of its application is extremely limited.

### SUMMARY OF THE INVENTION

The primary purpose of the present invention is to provide synthetic leather and a manufacturing process thereof that gives advantages of good fastness to prevent stripping off, and good air permeability, and more importantly, its lateral and longitudinal ductility and malleability meet requirements. In addition, the synthetic leather of the present invention is characterized in smooth surface that withstands friction without pilling, allowing diversified types of applicable substrate, and ideal for mass production by batch.

To achieve the purpose, a substrate, and synthetic fiber is preferred, is selected to go through fiber opening and carding procedures and then combined with a thermoplastic basic material (TPU MB thermoplastic-polyurethane melt-blown non-woven) to become a compound material, which is then put through an embossed pattern press process as required to come up with a synthetic leather of the present invention.

The combination of the substrate and the thermoplastic material is done at least once and may be repeated as many times as required.

The method of combining the substrate and the thermoplastic material includes but not limited to a water entangle method, a needle punch method, a melt brown method, a hot air lamination method, or an adhesive binding method.

### BRIEF DESCRIPTION OF THE DRAWINGS

FIG. 1 is a schematic view showing a flow path of a one-time compound procedure for manufacturing a synthetic leather of the present invention.

FIG. 2 is a schematic view showing a construction of the synthetic leather of the present invention manufactured using the one-time compound method.

FIG. 3 is a schematic view showing a flow path of a multiple-time compound procedure for manufacturing the synthetic leather of the present invention.

FIG. 4 is a schematic view showing a construction of the synthetic leather of the present invention manufactured using the multiple-time compound method.

### DETAILED DESCRIPTION OF THE PREFERRED EMBODIMENTS

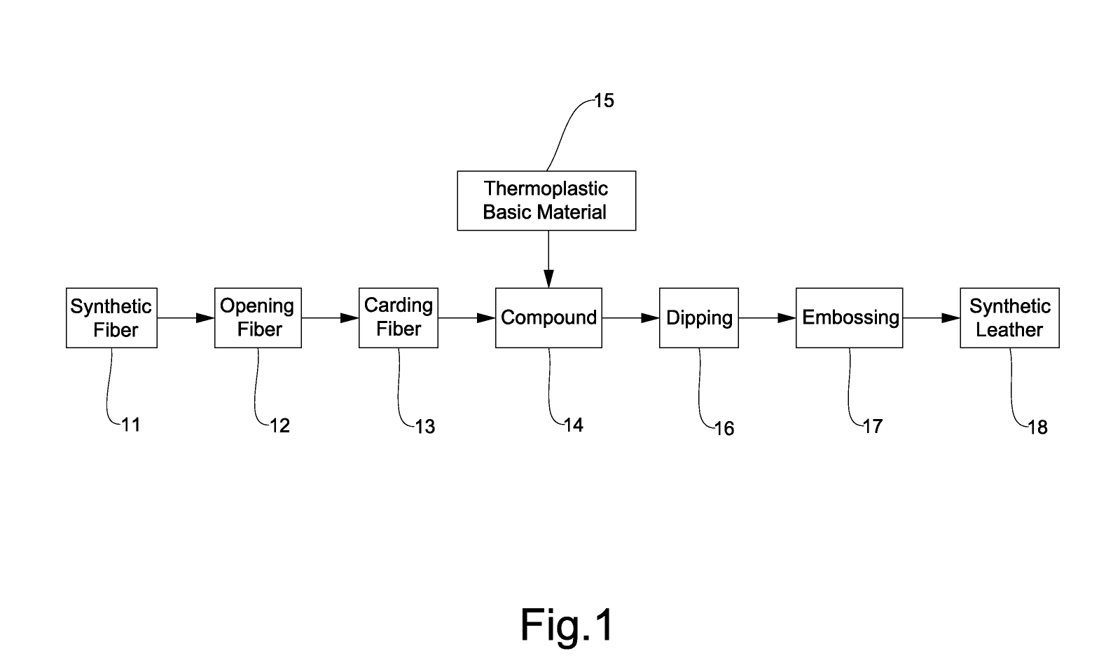

Referring to FIG. 1, a synthetic fiber 11 is selected as a substrate; the synthetic fiber is then put through fiber opening procedure 12 and fiber carding procedure 13 before being put into a compound procedure 14 to combine with a thermoplastic basic material (TPU MB thermoplastic-polyurethane melt-blown non-woven) 15 to become a compound material; and finally, the compound material is further going through a dipping process 16 and an embossing process 17 using an embossed pattern hot roller to press a pattern on the surface of the compound material to have a final product of a synthetic leather 18.

The synthetic fiber 11 may be related to Polyethylene Terephthalate (PET), polyester, nylon, cellulose, rayon, ES fiber, other any synthetic fiber, activated carbon fiber, stainless steel fiber, wool, cotton, flax, or a mixture of cotton and flax.

The compound procedure 14 involves having pressurized water (40˜120 kg/cm2) to produce an extremely minute water jet in thickness as that of a needle (0.1 mm) to directly spray on the synthetic fiber 11 and the thermoplastic basic material (TPU MB thermoplastic-polyurethane melt-blown non-woven) 15 for their fibers to get entangled and become a compound material by taking advantage of rebounding action provided by the water.

The compound procedure 14 includes but not limited to a water entangle method, a needle punch method, a melt blown method, a hot air lamination method, or an adhesive binding method.

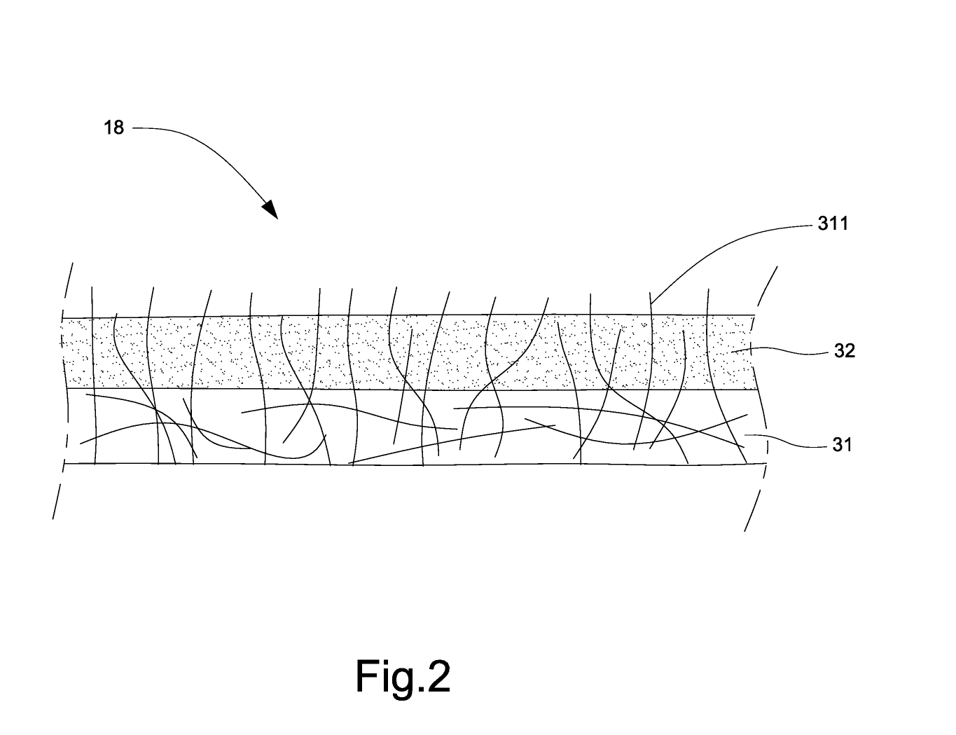

Now referring to FIG. 2, the finished product of the synthetic leather 18 using the manufacturing process as illustrated in FIG. 1 is substantially comprised of a substrate layer 31 at the bottom and a thermoplastic basic material layer 32 compounded on top of the substrate layer 31.

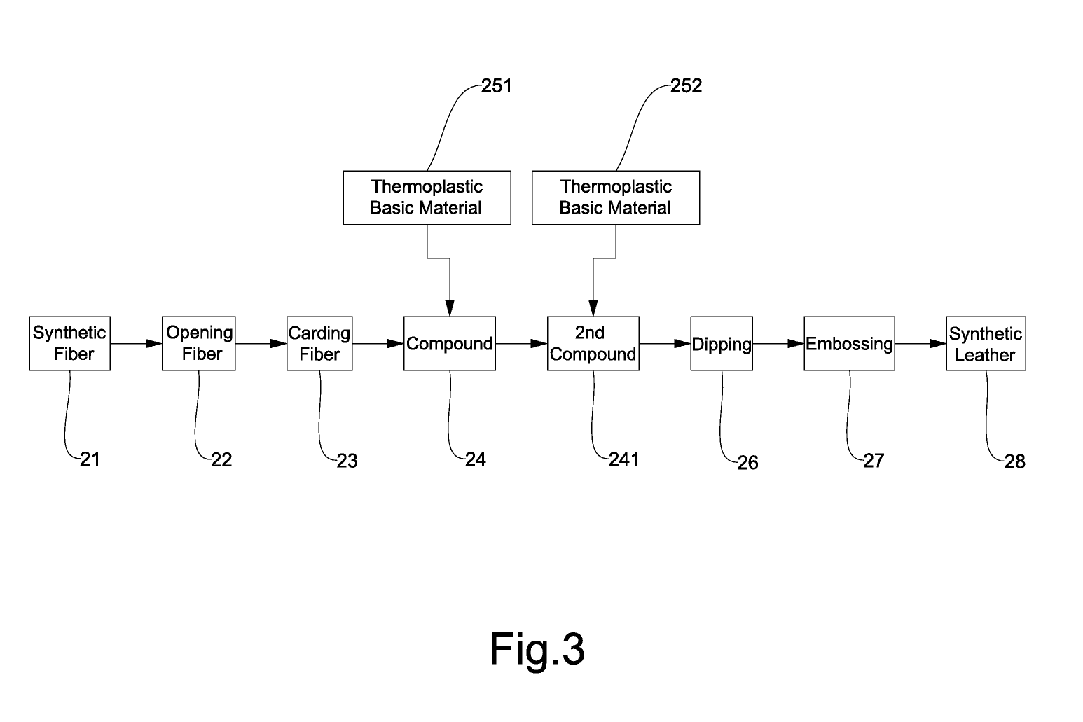

In another preferred embodiment of the manufacturing process of the present invention as illustrated in FIG. 3, a synthetic fiber 21 is selected as the substrate, and the synthetic fiber is put through a fiber opening procedure 22 and a fiber carding procedure 23 before entering into a compound procedure 24 to combine with a thermoplastic basic material of Thermoplastic Polyurethane Melt Blown Nonwoven (TPU MB thermoplastic-polyurethane melt-blown non-woven) 251 followed with a second compound process with the thermoplastic basic material TPU MB 252. The resultant compound material is then put through a dipping process 26 and an embossing process 27 using an embossed pattern hot roller to press a pattern on the surface of the compound material to have a final product of a synthetic leather 28.

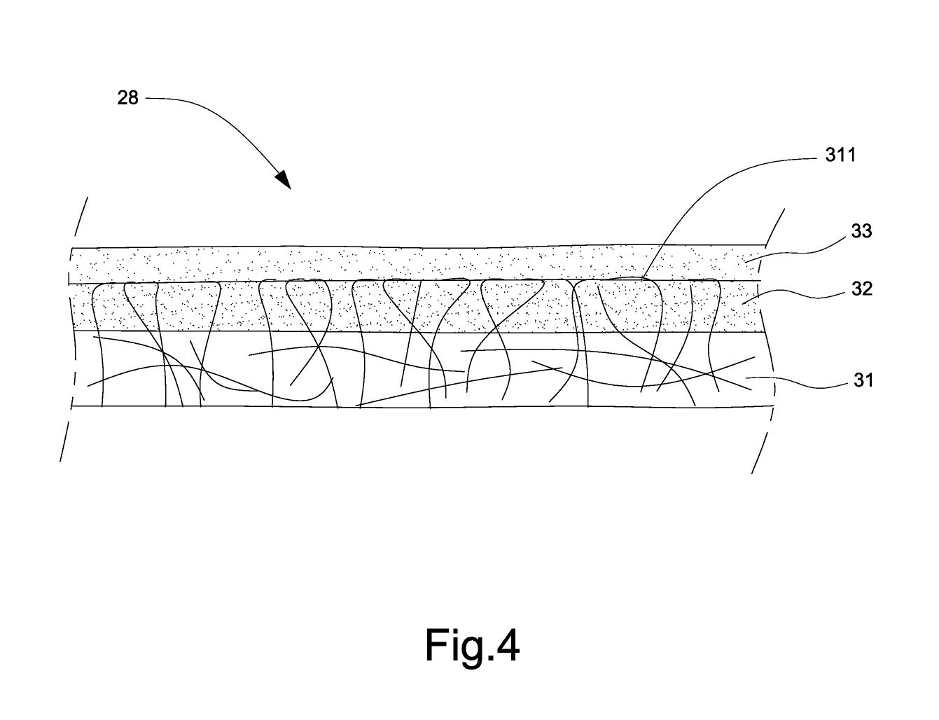

As illustrated in FIG. 4, the construction of the synthetic leather 28 is comprised of a substrate layer 31 in an integrated compound, a thermoplastic basic material layer 32, and a secondary layer 33 of thermoplastic basic material. It appears that certain portion of fiber 311 from the substrate layer 31 is covered inside the secondary layer 32 of thermoplastic basic material.

The preferred embodiment differs from the previous preferred embodiment in that the compound procedure is given twice 24, 241 or more; and the advantages of repeated procedures of compound are:

1. When compared to the one-time compound procedure, the secondary compound procedure 241 to combine the thermoplastic basic material TPU MB 252 allows few protruding fibers 311 as illustrated in FIG. 2 from the thermoplastic basic material layer 32 are effectively concealed inside the secondary layer 33 of the thermoplastic basic material as illustrated in FIG. 4 to be prevented from penetrating through the secondary layer 33 of the thermoplastic basic material; therefore, the surface of the synthetic leather 28 becomes comparatively smooth, withstanding friction, and free of pilling. Furthermore, the color of the surface looks even more consistent since those fibers 311 are effectively concealed.

2. Variance of the substrate material is enriched to allow the use of various types of synthetic fiber, activated carbon fiber, stainless steel fiber, wool, cotton, etc. for developing diversified products and achieving even more comprehensive application. For example, a synthetic leather with stainless steel fiber as the substrate so that when it is applied in a power massage chair, the performance of the synthetic leather of the present invention in withstanding continuous friction, force applied, and plunging by internal mechanism of the power massage chair is far better than any other synthetic leathers generally available in the market, thus to deliver longer service life, more durable properties, and more capability of withstanding friction.

3. The synthetic leather of the present invention manufactured in multiple-time compound procedures gives a construction better than that made using one-time compound procedure and simulates the advantage of preventing easy stripping off as provided by the genuine leather due to the repeated compound procedure 241 to combine the thermoplastic basic material TPU MB 252 as illustrated in FIG. 4 to effectively conceal those fibers 311 otherwise exposed from the thermoplastic basic material layer 32 by being sandwiched between the second layer 33 of the thermoplastic basic material and the thermoplastic basic material layer 32.

4. The additional compound procedure 241 to combine the thermoplastic basic material TPU MB 252 allows reuse of those wastes of dyed TPU MB produced from purging the manufacturing equipment (i.e., feeding the thermoplastic basic material into the mechanical equipment to expel dyestuff attached to the mechanical equipment) otherwise to be disposed to be used as the thermoplastic basic material 251 (i.e., the thermoplastic basic material layer 32 since its appearance will be fully covered up by the secondary layer 33 of the thermoplastic basic material) for effective use of materials and reducing material consumption and production cost.

5. For the finished product to be dyed, it takes only to add color to the outmost secondary layer 33 of the thermoplastic basic material 33 thus to effectively reduce the dyeing cost.

6. The present invention allows reduction of inventory level and thus the inventory maintenance costs since the thermoplastic basic material 252 (i.e., the secondary layer 33 of the thermoplastic basic material) may be produced in massive quantity with the corresponding dyestuff prepared for future production by batch. While being free of color difference between batches, the key point is to reduce inventory level and inventory maintenance cost.

Even though the multiple-time compound procedure does provide those advantages as describe above, the synthetic leather manufactured using the one-time compound method gives also the advantage of lower production cost. It is to be noted that those advantages provide by either compound method for manufacturing the synthetic leather of the present invention should fall within the scope of the purposes and claims of the present invention.

I claim,:

1. A manufacturing method of a synthetic leather comprising the following steps:
selecting a substrate;
combing the substrate and a thermoplastic basic material in a one-time compound procedure for both to get entangled with each other into an integrated part; and
obtaining a finished product of the synthetic leather.

2. The manufacturing method as claimed in claim 1, wherein the substrate is related to a synthetic fiber of Polyethylene Terephthalate (PET), polyester, nylon, cellulose, rayon, ES fiber, activated carbon fiber, stainless steel fiber, wool, cotton, flax, or a mixture of cotton and flax.

3. The manufacturing process as claimed in claim 1, wherein the combination of the substrate and the thermoplastic material are done at least once and are repeated as many times as required.

4. The manufacturing process as claimed in claim 3, wherein the step of combining the substrate and the thermoplastic material includes using a water entangle method, a needle punch method, a melt brown method, a hot air lamination method, or an adhesive binding method.

5. A synthetic leather containing in construction thereof a substrate layer and a thermoplastic basic material layer integrated in one part by using a compound method.

6. The synthetic leather as claimed in claim 5, wherein the substrate is related to a synthetic fiber of Polyethylene Terephthalate (PET), polyester, nylon, cellulose, rayon, ES fiber, activated carbon fiber, stainless steel fiber, wool, cotton, flax, or a mixture of cotton and flax.

7. The synthetic leather as claimed in claim 5, wherein the thermoplastic basic material layer is related to a single layer and additional layer is provided as required.

8. The synthetic leather as claimed in claim 5, wherein the method of combining the substrate and the thermoplastic material includes using a water entangle method, a needle punch method, a melt brown method, a hot air lamination method, or an adhesive binding method.
